(19) United States
(12) Patent Application Publication
(10) Pub. No.: US 2026/0328353 A1
(43) Pub. Date: Oct. 22, 2026

(54) VEHICLE LAMP

(71) Applicant: KOITO MANUFACTURING CO., LTD., TOKYO (JP)

(72) Inventor: Tatsuki ITO, Shizuoka-shi, Shizuoka (JP)

(73) Assignee: KOITO MANUFACTURING CO., LTD., TOKYO (JP)

(21) Appl. No.: 19/116,846

(22) PCT Filed: Sep. 27, 2023
(86) PCT No.: PCT/JP2023/035301

§ 371 Date: Mar. 28, 2025

(30) Foreign Application Priority Data
Sep. 29, 2022 (JP) 2022-155687
Sep. 29, 2022 (JP) 2022-155688
Sep. 29, 2022 (JP) 2022-155689

(51) Int. Cl. F21S 41/25; B60Q 1/14

(52) U.S. Cl. CPC F21S 41/25; B60Q 1/1407

(57) ABSTRACT

A vehicle lamp includes: a low-beam light source unit; a high-beam light source unit; and a projection lens that projects light from each of the light source units to form a required light distribution. In the projection lens, a low-beam lens portion that projects light from the low-beam light source unit to form a low-beam light distribution and a high-beam lens portion that projects light from the high-beam light source unit to form a high-beam light distribution are integrally formed. The high-beam light source unit includes a correction optical part that reduces lens aberration.

### TECHNICAL FIELD

The present disclosure relates to a vehicle lamp that is suitably mounted on a vehicle such as an automobile.

### BACKGROUND ART

In order to simplify the structure of a vehicle lamp, in particular, a headlamp of an automobile, a lamp unit has been proposed in which projection lenses respectively corresponding to a plurality of light source units including a low-beam light source unit and a high-beam light source unit are integrated into one projection lens. For example, in Patent Literature 1, a low-beam light source unit and a high-beam light source unit are disposed corresponding to one projection lens, and light emitted from each light source unit is projected by the one projection lens to form a required low-beam light distribution and high-beam light distribution. In Patent Literature 2, three low-beam light source units are disposed corresponding to one projection lens.

### CITATION LIST

### Patent Literature

Patent Literature 1: WO2021/261559A1

Patent Literature 2: WO2013/183240A1

### SUMMARY OF INVENTION

### Technical Problem

When the low-beam light distribution and the high-beam light distribution are projected by one projection lens as described above, lens aberration caused in the high-beam light distribution becomes a problem. That is, the high-beam light source unit is often configured such that divergent light emitted from the light source is directly incident on the projection lens in order to achieve a wide high-beam light distribution with high illuminance (brightness). Therefore, an incident angle when part of the light emitted from the high-beam light source unit is incident on the projection lens becomes large, and there is a problem that lens aberration, in particular, coma aberration occurs.

An object of the present disclosure is to provide an integrated lamp unit capable of high-beam light distribution and low-beam light distribution, in particular, a vehicle lamp that reduces lens aberration in the high-beam light distribution.

In a case in which one projection lens has a plurality of different lens shapes, usually a convex spherical surface or curved surface, formed on a front surface of the projection lens, when the projection lens is observed from a front side, the plurality of different lens shapes appearing on the front surface become a factor of deteriorating the appearance of an illumination lamp unit and deteriorating the design.

An object of the present disclosure is to provide a vehicle lamp in which the design of a projection lens is improved in a lamp unit in which a plurality of light source units, in particular, a plurality of light source units having different configurations are configured corresponding to the projection lens.

When an illumination lamp unit is configured by selectively adopting high-beam light source units having different structures, a high-beam lens portion of the projection lens is formed into a lens shape suitable for the corresponding light source unit. In such a case, when a lens shape of a front surface of the projection lens is different according to the difference in the high-beam light source units, the uniformity of the appearance of the illumination lamp unit is impaired, and a problem of design occurs. The same applies to a lamp unit in which low-beam light source units having different configurations are selectively adopted.

An object of the present disclosure is to provide a vehicle lamp that includes a lamp unit including a high-beam light source unit, a low-beam light source unit, and a projection lens in which lens portions corresponding to the respective light source units are integrally formed, in which the design of the projection lens is improved regardless of a difference in configuration of the light source units.

### Solution to Problem

A vehicle lamp of the present disclosure includes: a low-beam light source unit; a high-beam light source unit; and a projection lens that projects light from each of the light source units to form a required light distribution, in which in the projection lens, a low-beam lens portion that projects light from the low-beam light source unit to form a low-beam light distribution and a high-beam lens portion that projects light from the high-beam light source unit to form a high-beam light distribution are integrally formed, and the high-beam light source unit includes a correction optical part that reduces lens aberration.

According to the present disclosure, when a lamp unit is configured with high-beam and low-beam light source units corresponding to one projection lens, a vehicle lamp that reduces lens aberration in the high-beam light distribution can be obtained.

The vehicle lamp according to the present disclosure includes: a plurality of low-beam light source units; and a projection lens that projects light from the plurality of low-beam light source units forward to form a required light distribution, in which in the projection lens, a plurality of lens portions that project light from the plurality of low-beam light source units to form different light distributions are integrally formed, a front surface of the projection lens is formed as a uniform curved surface or flat surface, and a rear surface of the projection lens is formed such that at least one of the lens portions has a different curved surface. For example, the front surface of the projection lens is a curved surface that is curved in both a vertical direction and a horizontal direction. In this case, a vertical cross section of the front surface of the projection lens is preferably an arc surface having a required curvature.

The vehicle lamp according to the present disclosure includes: a low-beam light source unit; a high-beam light source unit; and a projection lens that projects light from each of the light source units to form a required light distribution, in which in the projection lens, a low-beam lens portion that projects light from the low-beam light source unit to form a low-beam light distribution and a high-beam lens portion that projects light from the high-beam light source unit to form a high-beam light distribution are integrally formed, a front surface of the projection lens is formed as a uniform curved surface or flat surface, and a rear surface of the projection lens is formed such that at least one of the lens portions has a different curved surface.

According to the present disclosure, when a lamp unit is configured with light source units having different configurations corresponding to one projection lens, a front surface of the projection lens is formed as a uniform curved surface or flat surface, and thus a vehicle lamp with improved design can be obtained.

The vehicle lamp according to the present disclosure includes: a low-beam light source unit; a high-beam light source unit; and a projection lens that projects light from each of the light source units to form a required light distribution, in which a low-beam lens portion that projects light from the low-beam light source unit to form a low-beam light distribution and a high-beam lens portion that projects light from the high-beam light source unit to form a high-beam light distribution are integrally formed, the light source units are capable of having different structures, and a front surface of the projection lens has the same lens shape regardless of a difference in the light source units. That is, the front surface of the projection lens is formed as a uniform curved surface or flat surface, and a rear surface of the projection lens is formed with different curved surfaces corresponding to the disposed light source units.

According to the present disclosure, in a lamp unit including a high-beam light source unit and a low-beam light source unit corresponding to one projection lens, the uniformity in the appearance of the projection lens can be regardless of a difference in configuration of the light source units, and a vehicle lamp with improved design can be obtained.

### Advantageous Effects of Invention

According to the vehicle lamp according to the present disclosure, it is possible to obtain a vehicle lamp that reduces lens aberration in high-beam light distribution and has improved design.

### BRIEF DESCRIPTION OF DRAWINGS

FIG. 1A is a schematic perspective view of an automobile equipped with a vehicle lamp according to an embodiment.

FIG. 1B is an exploded perspective view of a part of the automobile equipped with the vehicle lamp according to the embodiment.

FIG. 2 is a schematic exploded perspective view of an illumination lamp unit according to Embodiment 1.

FIG. 3 is a schematic plan view of the illumination lamp unit according to Embodiment 1.

FIG. 4A is a cross-sectional view and a light distribution diagram of a concentration Lo light source unit.

FIG. 4B is a cross-sectional view and a light distribution diagram of a diffusion Lo light source unit.

FIG. 4C is a cross-sectional view and a light distribution diagram of a diffusion Lo light source unit.

FIG. 4D is a cross-sectional view and a light distribution diagram of a diffusion Lo light source unit.

FIG. 5 is a perspective view of a projection lens from a rear side.

FIG. 6 is a schematic diagram illustrating a light distribution of a Hi light source unit.

FIG. 7A is a light distribution diagram illustrating a Hi light distribution.

FIG. 7B is a light distribution diagram illustrating the Hi light distribution.

FIG. 8 is a schematic diagram illustrating the reduction of coma aberration.

FIG. 9A is a schematic diagram illustrating glare caused by the coma aberration.

FIG. 9B is a schematic diagram illustrating the glare caused by the coma aberration.

FIG. 9C is a schematic diagram illustrating the glare caused by the coma aberration.

FIG. 10 is a schematic exploded perspective view of an illumination lamp unit according to Embodiment 2.

FIG. 11A is an enlarged perspective view of a part of a Hi light source unit according to Embodiment 2.

FIG. 11B is an enlarged perspective view of a part of the Hi light source unit according to Embodiment 2.

FIG. 12 is a schematic exploded perspective view of an illumination lamp unit according to Embodiment 3.

FIG. 13 is a schematic exploded perspective view of an illumination lamp unit according to Embodiment 4.

FIG. 14 is a schematic plan view of the illumination lamp unit according to Embodiment 4.

FIG. 15A is a cross-sectional view and a light distribution diagram of a Hi light source unit for Bi light distribution control.

FIG. 15B is a cross-sectional view and a light distribution diagram of the Hi light source unit for the Bi light distribution control.

### DESCRIPTION OF EMBODIMENTS

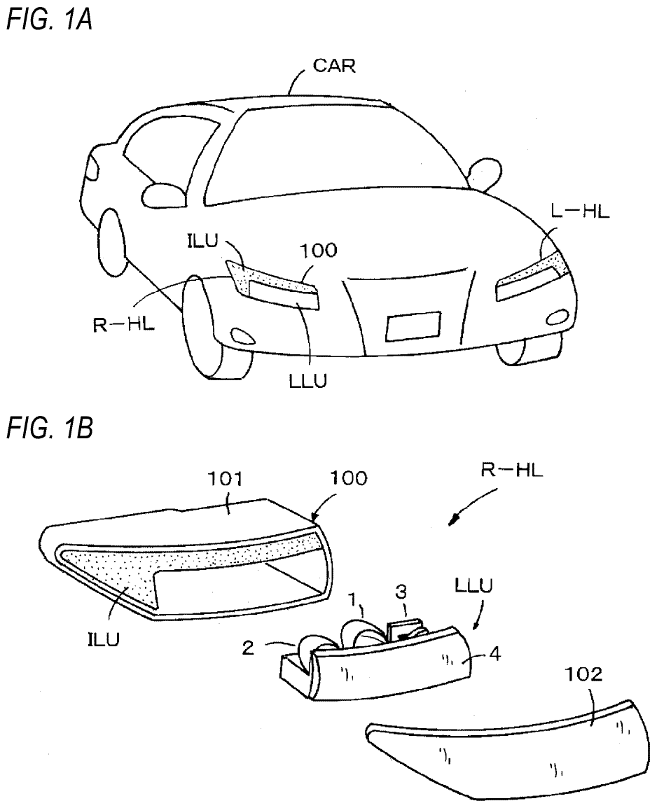

Hereinafter, the embodiments of the present disclosure will be described with reference to the drawings. FIG. 1A is a schematic perspective view of an automobile CAR including left and right headlamps L-HL and R-HL applied as a vehicle lamp of the present disclosure. Since the left and right headlamps L-HL and R-HL are symmetrical except for some configurations, the right headlamp R-HL will be mainly described below, but may be simply referred to as a headlamp HL. The right headlamp R-HL is disposed in a right front portion of a vehicle body of the automobile CAR, and is configured as a composite headlamp in which an illumination lamp unit LLU and an indicator lamp unit ILU are disposed in a lamp housing 100 attached to the vehicle body. In the following description, a front-rear direction basically refers to a front-rear direction of the automobile CAR, and a left-right direction basically refers to a vehicle width direction of the automobile CAR.

FIG. 1B is a schematic perspective view showing a part of the right headlamp R-HL in an exploded state. The lamp housing 100 includes a lamp body 101 having an opening extending from the front to the side of the vehicle, and a translucent outer cover 102 attached to cover the opening of the lamp body 101. The outer cover 102 is also referred to as a translucent cover or an outer lens, and is configured as a transparent lens made of a colorless translucent resin or the like. A surface of the outer cover 102 is formed as a slightly curved surface following a curved shape of the right front portion of the vehicle body of the automobile CAR.

The illumination lamp unit LLU is disposed in a lower portion of the lamp housing 100, and the indicator lamp unit ILU is disposed in an upper portion of the lamp housing 100. The illumination lamp unit LLU has a light-emitting surface having a shape close to a horizontally long rectangle with a longer side oriented in the vehicle width direction when viewed from a front side. The indicator lamp unit ILU has, on an upper side of the illumination lamp unit 1, a light-emitting surface having a shape close to an elongated strip extending in the vehicle width direction.

Although details will be described later, the illumination lamp unit LLU has a plurality of embodiments, and a low-beam (hereinafter, Lo) light source unit and a high-beam (hereinafter, Hi) light source unit are assembled corresponding to one projection lens. When the Lo light source unit emits light, illumination is provided with a predetermined Lo light distribution, and when the Hi light source unit emits light, illumination is provided with a Hi light distribution, in this case, an adaptive driving beam (ADB)-Hi light distribution.

Here, the indicator lamp unit ILU is configured as a lamp unit that functions as a clearance lamp (CL) or a daytime running lamp (DRL) that emits white light to indicate the presence of a host vehicle. The indicator lamp unit ILU is less related to the present disclosure, and thus detailed description thereof will be omitted, but the indicator lamp unit ILU includes a strip-shaped light guide extending in the vehicle width direction along an upper edge of the illumination lamp unit LLU and a white LED that emits white light. When the white LED emits light, the emitted white light passes through the light guide and is emitted, and thus the CL or DRL is turned on.

Alternatively, the indicator lamp unit ILU may include a plurality of white LEDs disposed in the vehicle width direction and a projection lens that is elongated in the vehicle width direction and disposed in front of the LEDs. In this configuration, when the white LEDs emit light, the emitted white light passes through the projection lens and is emitted, and thus the CL or DRL is turned on. The indicator lamp unit ILU may further include an amber LED that emits amber light, and in this case, the indicator lamp unit ILU is also configured as a turn signal lamp (TSL) having a signal lamp function.

### Embodiment 1

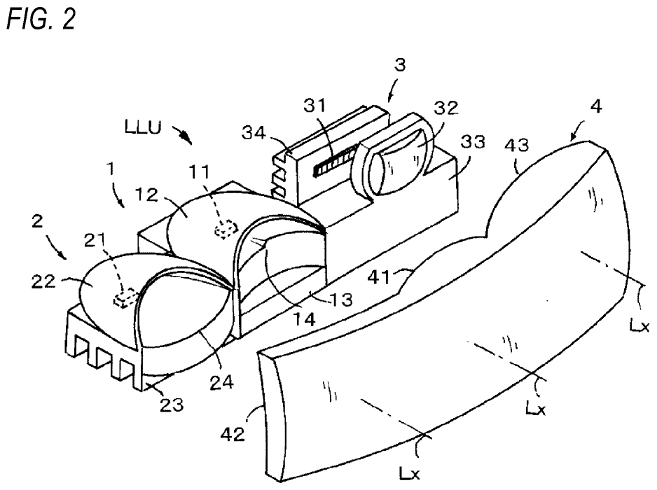

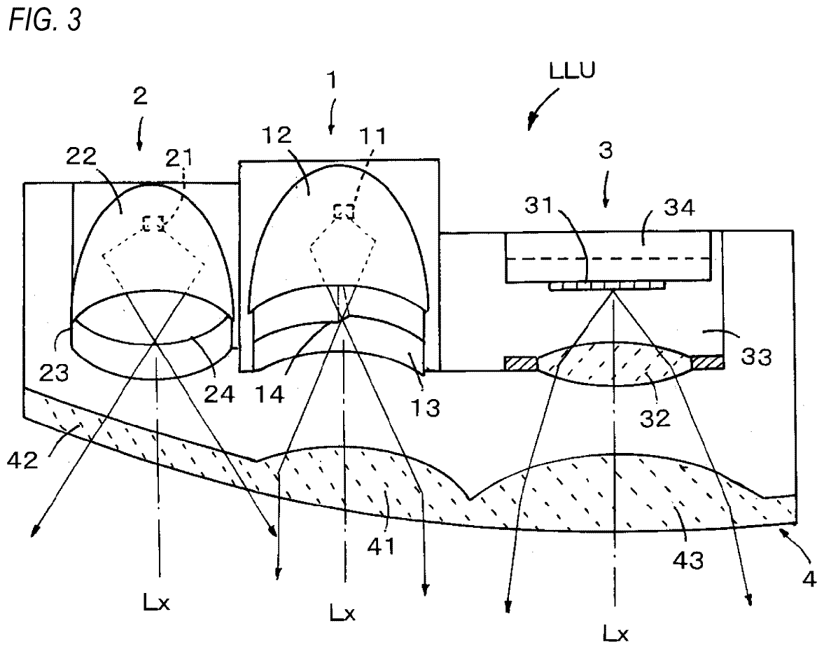

FIG. 2 is a partially exploded perspective view of Embodiment 1 of the illumination lamp unit LLU in the right headlamp R-HL described above, and FIG. 3 is a schematic plan cross-sectional view. The illumination lamp unit LLU includes two Lo light source units, that is, a first Lo light source unit 1 and a second Lo light source unit 2, and one Hi light source unit 3 for one projection lens 4, and the light source units 1, 2, and 3 shares the one projection lens 4 to constitute projector-type lamps, respectively.

The two Lo light source units 1 and 2 are disposed outside in the vehicle width direction, and the one Hi light source unit 3 is disposed inside in the vehicle width direction. As will be described later, the first Lo light source unit 1 is configured as a concentration Lo light source unit that provides concentrated illumination to a central region of light distribution, that is, a region in the vicinity of an intersection (hereinafter, referred to as an HV point) of a horizontal line H and a vertical line V serving as a reference of light distribution when illuminating the front of an automobile. The second Lo light source unit 2 is configured as a diffusion Lo light source unit that illuminates a wide region including the light concentration region at a relatively low illuminance.

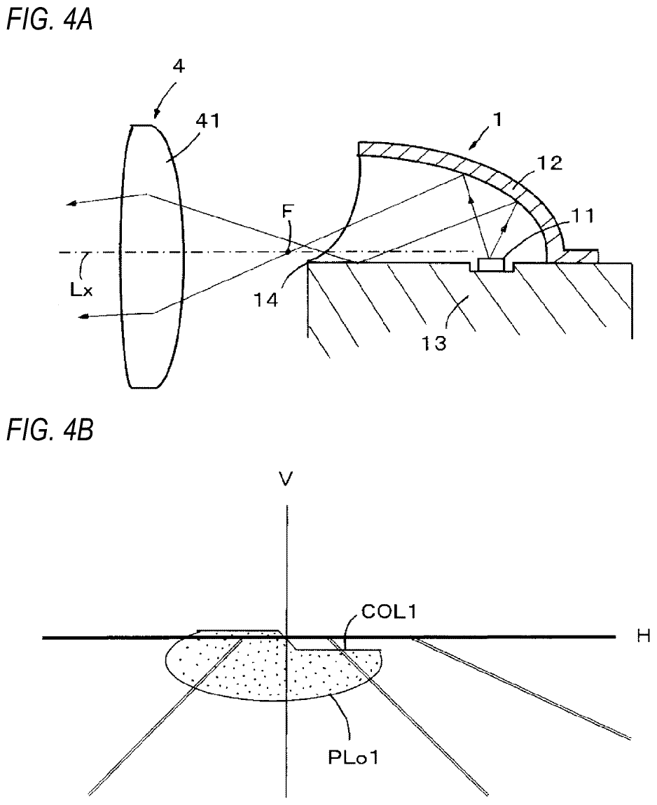

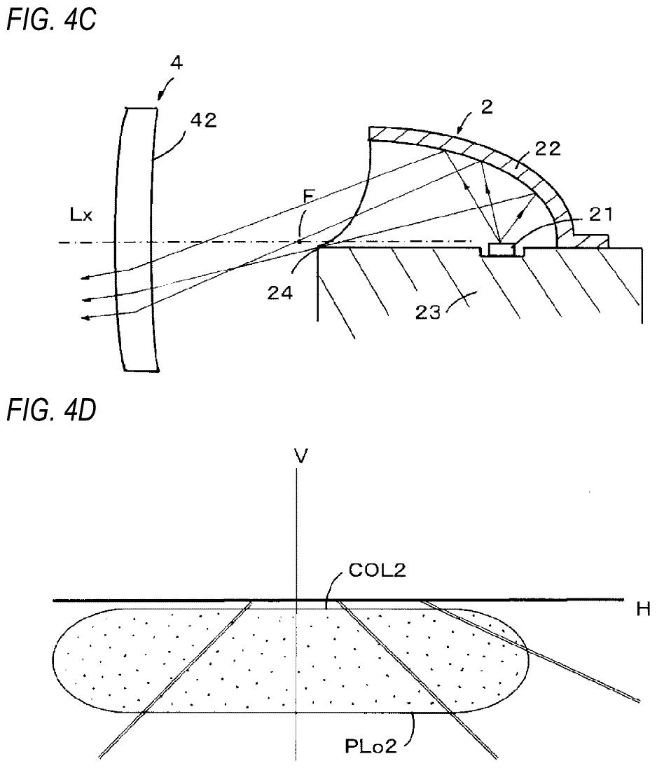

With reference to the vertical cross-sectional view of FIG. 4A, the first Lo light source unit, that is, the concentration Lo light source unit 1 includes a white LED 11 as a light source and a reflector 12 that reflects white light emitted from the white LED 11 forward. The white LED 11 is configured by a chip-type LED that emits white light, and is mounted on a unit body 13 with a light-emitting surface thereof facing vertically upward. The unit body 13 is configured as, for example, a heat sink, the white LED 11 is mounted on an upper surface thereof via a required attachment, and power is supplied for light emission through wiring (not shown).

The reflector 12 is configured as a concave reflecting mirror based on an ellipsoid of revolution, and the white LED 11 is disposed at a first focal point thereof. Actually, the reflector 12 has a shape in which the flattening ratio of the ellipse gradually decreases from a vertical cross section including a major axis of the ellipse toward a horizontal cross section. A front end edge of an upper surface of the unit body 13 is configured as a shade 14, and has a planar shape that is curved in a concave shape toward the front.

With reference to the vertical cross-sectional view of FIG. 4C, the second Lo light source unit, that is, the diffusion Lo light source unit 2 has a basic configuration similar to that of the concentration Lo light source unit 1. That is, the diffusion Lo light source unit 2 includes a white LED 21 as a light source and a reflector 22 that reflects white light emitted from the white LED 21 forward. The white LED 21 is configured by a chip-type LED that emits white light, and is mounted on a unit body 23 with a light-emitting surface thereof facing vertically upward. The reflector 22 is configured as a concave reflecting mirror based on an ellipsoid of revolution, and the white LED 21 is disposed at a first focal point thereof. A front end edge of an upper surface of the unit body 23 is configured as a shade 24, and the shade 24 has a planar shape that is curved in a convex shape toward the front, contrary to the concentration Lo light source unit 1.

As shown in FIG. 3, the Hi light source unit 3 includes a plurality of white LEDs 31 as light sources, and a correction lens 32 that converges light emitted from the white LEDs to some extent. The plurality of white LEDs 31 are constituted by ten chip-type LEDs, and are mounted side by side in a row in the vehicle width direction on a front surface of a base wall 34 erected on a unit body 33 with respective light-emitting surfaces facing forward. These ten white LEDs 31 are disposed configured such that an interval dimension in the vehicle width direction between adjacent white LEDs gradually increases from an outer side of a vehicle width to an inner side of the vehicle width (the center of the vehicle width) of the automobile, which will be described in detail later.

The correction lens 32 is disposed in front of the ten white LEDs 31, and is configured such that the white light emitted from the light-emitting surface of each of the white LEDs 31 is incident thereon. The correction lens 32 is configured as a lens having a positive refractive power, in this case, a convex lens, and is configured to refract the white light emitted in a divergent state from the each of the white LEDs 31 in a converging direction and cause the white light to enter the projection lens 4. The correction lens 32 is assembled integrally with the Hi light source unit 3, but may be configured separately.

On the other hand, the projection lens 4 shown in FIG. 3 is configured as a common projection lens for forming respective light distributions of the two Lo light source units 1 and 2 and the one Hi light source unit 3, and is disposed over a region in front of the two Lo light source units 1 and 2 and the one Hi light source unit 3. The projection lens 4 is also referred to as an inner lens, and is configured as the light-emitting surface of the illumination lamp unit LLU and is made of a translucent material in a shape close to a horizontally long rectangle with a longer side oriented in the vehicle width direction.

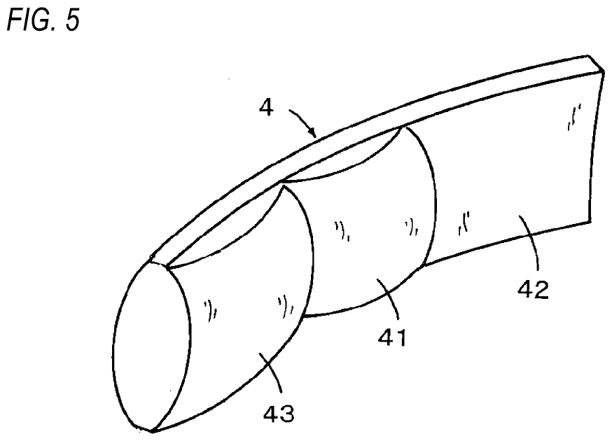

FIG. 5 is a perspective view of the projection lens 4 viewed from a rear side, and the projection lens 4 is divided in the vehicle width direction corresponding to the light source units 1, 2, and 3. Hereinafter, the divided portions are referred to as lens portions for convenience. That is, the portions facing the concentration Lo light source unit 1, the diffusion Lo light source unit 2, and the Hi light source unit 3 are referred to as a concentration Lo lens portion 41, a diffusion Lo lens portion 42, and a Hi lens portion 43, respectively.

A front surface of the projection lens 4 is formed as a uniform curved surface over the entire area. That is, a vertical cross section of each of the lens portions 41 to 43 is an arc surface having a convex shape with a required curvature or a curved surface close to the arc surface. On the other hand, a horizontal cross section of each of the lenses 41 to 43 is formed as a curved surface that gently extends rearward from a vehicle center side toward a vehicle width outer side direction following the curved shape of the outer lens 102 of the lamp housing 100. Therefore, the front surface of the projection lens 4 is configured as a uniform curved surface that is curved in both a vertical direction and a horizontal direction, and when the projection lens 4 is observed from a front side, the front surface thereof is observed as a smooth continuous surface in which the division of the lens portions 41 to 43 cannot be distinguished, and the design effect in this respect can be enhanced.

The shapes of the lens portions 41 to 43 on a rear surface of the projection lens 4 are different. A rear surface of the concentration Lo lens portion 41 is formed as a convex spherical surface or aspheric surface having a required curvature at least in the horizontal direction. The rear surface is formed as a similar convex curved surface in the vertical direction. With these surface shapes, the concentration Lo lens portion 41 is configured as a biconvex lens, and is configured as a lens portion with a positive refractive power that converges light in both the horizontal direction and the vertical direction.

As shown in FIG. 4A, a focal point F on an optical axis Lx of the concentration Lo lens portion 41 is set at a position in the vicinity of a second focal point of the reflector 12 of the concentration Lo light source unit 1, in other words, at a position in the vicinity of the shade 14. The rear surface of the concentration Lo lens portion 41 may be a concave surface as long as the concentration Lo lens portion 41 is configured as a lens portion having a positive refractive power in both the horizontal direction and the vertical direction.

A rear surface of the diffusion Lo lens portion 42 is formed as a flat surface or a curved surface that generates a positive refractive power in the vertical direction. Here, the rear surface is formed as a curved surface having a smaller curvature than the front surface, and the diffusion Lo lens portion 42 is configured as a meniscus lens and is formed thinner than the concentration Lo lens portion 41. On the other hand, in the horizontal direction, as shown in FIG. 3, the rear surface is formed as a curved surface parallel to the front surface, and therefore has no refractive power as a lens in the horizontal direction. In other words, the diffusion Lo lens 42 is configured as a cylindrical lens curved in the horizontal direction.

The diffusion Lo lens portion 42 has an optical axis Lx and a focal point F that can be specified in the vertical direction, but has a planar shape or a linear shape that extends horizontally in the horizontal direction. As shown in FIG. 4C, the optical axis Lx and the focal point F are set at a position in the vicinity of the second focal point of the reflector 22 of the diffusion Lo light source unit 2, that is, at the position of the shade 24.

Similarly to the concentration Lo lens portion 41, a rear surface of the Hi lens portion 43 is formed as a convex spherical surface or aspheric surface having a required curvature in the horizontal direction, and is formed as a similar convex spherical surface or aspheric surface in the vertical direction. With these surface shapes, the Hi lens portion 43 is configured as a lens portion with a positive refractive power that converges light in both the horizontal direction and the vertical direction, and is formed to be the thickest among the three lens portions.

An optical axis Lx of the Hi lens portion 43 coincides with the optical axis of the correction lens 32. The position of the optical axis Lx in the vertical direction coincides with a height of the white LED 41, and the position of the optical axis Lx in the horizontal direction coincides with a predetermined position set as a center position of the white LED 31 in the horizontal direction. The rear surface of the Hi lens portion 43 may also be a concave surface as long as the Hi lens portion 43 is configured as a lens portion having a positive refractive power in both the horizontal direction and the vertical direction.

The above three light source units 1, 2, and 3 and one projection lens 4 may be separately configured and independently disposed in the lamp housing 100. Alternatively, the two Lo light sources 1 and 2 may be integrally assembled and disposed in the lamp housing 100. Further, the three light source units 1, 2, and 3 may be integrally assembled and disposed in the lamp housing 100. In this case, the projection lens 4 and the three light source units 1, 2, and 3 may be integrally assembled.

The operation of the illumination lamp unit having the above configuration will be described. When the headlamp HL is turned on with Lo beam light distribution, the two Lo light source units 1 and 2 are simultaneously put into a light emitting state. In the concentration Lo light source unit 1, as shown in FIG. 4A, the white light emitted from the white LED 11 is reflected forward by the reflector 12 and converged in the vicinity of the second focal point, and part of the white light is reflected by a surface of the unit body 13. The white light that is not blocked by the shade 14 is incident on the concentration Lo lens portion 41 of the projection lens 4. As shown in FIG. 3 as well, since the concentration Lo lens portion 41 has a refractive power in the vertical direction and the horizontal direction, the white light is emitted to the front of the automobile by the concentration Lo lens portion 41.

Since the shade 14 of the concentration Lo light source unit 1 is formed in a stepped shape in the horizontal direction as described above, as shown in FIG. 4B, a cutoff line (hereinafter, referred to as a CO line), here, a stepped CO line COL1 is formed in the projected white light, and a concentration Lo light distribution PLo1 can be obtained in which a lower region of the stepped CO line COL1 is illuminated with the white light. For example, the stepped CO line COL1 is lower on an oncoming lane side than on an own lane side, and is positioned at an angle of 0.57 degrees downward with respect to the horizontal line H on the oncoming lane side. In the concentration Lo light source unit 1, since the shade 14 has a concave shape facing forward, a sharp stepped CO line COL1 can be obtained in which lens aberration generated in the concentration Lo lens portion 41, in particular, curvature of field is eliminated or reduced. Further, since the vicinity of the HV point is illuminated with the concentrated white light by the refractive power of the concentration Lo lens portion 41 in the vertical direction and the horizontal direction, the concentration Lo light distribution PLo1 becomes a Lo light distribution including a relatively high illuminance region, that is, a hot zone.

In the diffusion Lo light source unit 2, as shown in FIG. 4C, the white light emitted from the white LED 21 is reflected by the reflector 22 and converged in the vicinity of the second focal point, and the white light that is not blocked by the shade 24 is incident on the diffusion Lo lens portion 42 of the projection lens 4. The diffusion Lo lens portion 42 has a refractive power in the vertical direction, but does not have a refractive power in the horizontal direction as shown in FIG. 3. Since the shade 24 of the diffusion Lo light source unit 2 has a convex shape facing forward, which is a convex shape corresponding to the curved shape of the diffusion Lo lens portion 42 in the horizontal direction, as shown in FIG. 4D, a straight line extending in the horizontal direction or a horizontal CO line COL2 close thereto is formed. The horizontal CO line COL2 is positioned at the same angle as the stepped CO line COL1 on the oncoming lane side, that is, at an angle of 0.57 degrees downward with respect to the horizontal line H.

Then, a region below the horizontal CO line COL2 is illuminated with the white light, and a diffusion Lo light distribution PLo2 is formed. Since the diffusion Lo lens portion 42 does not have a refractive power in the horizontal direction, the white light is diverged toward a wide angle in the horizontal direction, and a wide region in the left-right direction is illuminated with the white light. Since a region wider than the Lo light distribution PLo1 is illuminated with the white light, the light distribution has relatively low illuminance. In FIGS. 4A to 4D, the region illuminated with the white light is indicated by dots.

Since the Lo light distributions PLo1 and PLo2 by the concentration Lo light source unit 1 and the diffusion Lo light source unit 2 are combined, a Lo light distribution PLo is formed which illuminates wide regions in the horizontal direction below the stepped CO line COL1 and the horizontal CO line COL2 and has a hot zone of high illuminance in a straight-ahead direction of the automobile, that is, in the vicinity of the HV point. Although illustration of the Lo light distribution is omitted, the Lo light distribution is a combination of the light distributions in FIGS. 4B and 4D.

When the headlamp HL is turned on with Hi beam light distribution, the two Lo light source units 1 and 2 emit light and the white LEDs 31 of the Hi light source unit 3 emit light at the same time. The white light emitted from each of the white LEDs 31 is incident on the correction lens 32, and incident on the Hi lens portion 43 of the projection lens 4 after being transmitted through the correction lens 32. Since the Hi lens portion 43 has a refractive power in the vertical direction and the horizontal direction, the white light from each of the white LEDs 31 is projected forward of the automobile while being diverged in the vertical direction and the horizontal direction.

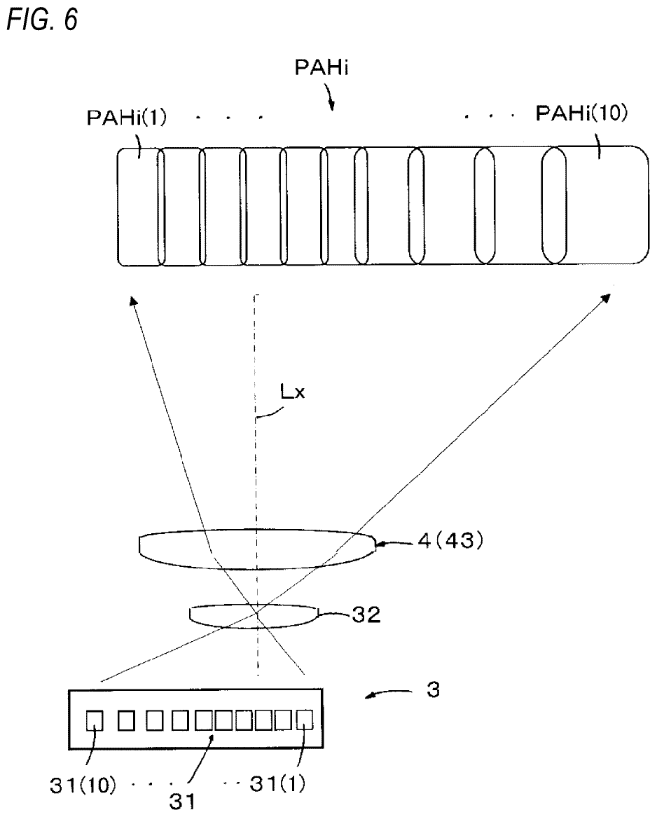

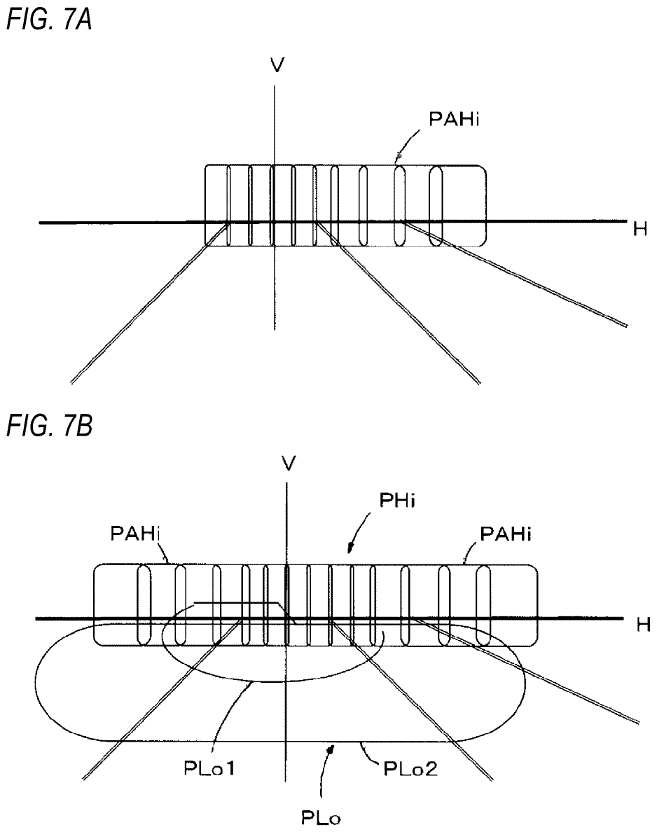

FIG. 6 is a schematic diagram illustrating a light distribution operation in the Hi light source unit 3. Since the ten white LEDs 31 [31 (1) to 31 (10)] are disposed in the horizontal direction, the white light from each of the white LEDs 31 is projected by the projection lens 4, and thus light distributions can be obtained in which a projection pattern of the white light is disposed in the horizontal direction. In Embodiment 1, the ten white LEDs 31 are disposed more densely in the horizontal direction on the white LED 31 (1) side closer to the optical axis Lx than on the white LED 31 (10) side away from the optical axis Lx. In other words, the interval dimension between the white LEDs 31 gradually increases as a distance from the optical axis Lx increases. Here, the pointillism of an illumination pattern is omitted.

In such an arrangement of the ten white LEDs 31, the white light from the white LED 31 (10) disposed away from the optical axis Lx has a larger incident angle with respect to the optical axis Lx than the white light from the white LED 31 (1) closer to the optical axis Lx. An enlarged width of this white light in the horizontal direction is increased by the lens aberration in the Hi lens portion 43. Therefore, due to the increase in the enlarged width in the horizontal direction, both sides of a projection pattern PAHi (10) of adjacent white light from the white LED 31 away from the optical axis Lx overlap each other, as shown in FIG. 6.

Accordingly, as shown in FIG. 7A, the white light from the ten white LEDs 31 is projected as a projection pattern aligned in the horizontal direction on an upper side including the horizontal line H. Since both sides of each of the projected projection patterns PAHi (1) to PAHi (10) of the white LEDs 31 overlap each other in the horizontal direction, each of the projection patterns has a continuous light distribution in the horizontal direction, and this light distribution is called Hi additional light distribution PAHi. Although illustration and description are omitted, in the Hi light source unit of the left headlamp L-HL, Hi additional light distribution PAHi symmetrical to the above Hi additional light distribution PAHi is formed. Therefore, a Hi light distribution PHi shown in FIG. 7B is formed by combining the Lo light distributions PLol and PLo2 and the left and right Hi additional light distributions PAHi on an upper side thereof.

In this configuration, since the ten white LEDs 31 are densely disposed in the horizontal direction on the white LED 31 (1) side closer to the optical axis Lx, the projected Hi additional light distribution PAHi has a higher illuminance on the side closer to the optical axis Lx than on the side away from the optical axis Lx in the horizontal direction. Accordingly, when the Hi additional light distribution PAHi is combined with the Lo light distribution PLo, a Hi light distribution PHi can be obtained in which the illuminance of a region continuous to the hot zone of the Lo light distribution PLo is higher than that of a peripheral region.

As described above, the Hi light source units 31 of the left and right headlamps are bilaterally symmetrical, and the arrangement of the ten white LEDs 31 is also bilaterally symmetrical. Therefore, by combining the Hi additional light distributions PAHi from the Hi light source units 31 of the left and right headlamps, the illuminance on the side closer to the optical axis is further increased, and at the same time, a Hi light distribution PHi can be obtained in which a wide region is illuminated to the left and right in the horizontal direction around the optical axis Lx.

In the Hi light source unit 3, during ADB light distribution control, the ten white LEDs 31 are selectively turned on or off. Therefore, when some of the white LEDs are turned off during the Hi light distribution, the region of the projection pattern of the white LEDs is formed as a light-blocking region. Therefore, when an oncoming vehicle or the like is present, the white LEDs 31 are selectively turned off such that a region where the oncoming vehicle is present becomes a light-blocking region, thereby implementing the ADB light distribution control that prevents glare for the oncoming vehicle.

Incidentally, with respect to the white light from the white LED 31 disposed away from the optical axis Lx, the lens aberration in the Hi lens portion 43, that is, the imaging blur, is utilized to increase the enlarged width of the projected light distribution, but undesirable effects due to the lens aberration cannot be ignored. That is, when the incident angle of the white light with respect to the optical axis increases, coma aberration, which is one type of lens aberration, becomes prominent, and boundaries of the projection patterns of the white light become unclear due to the coma aberration.

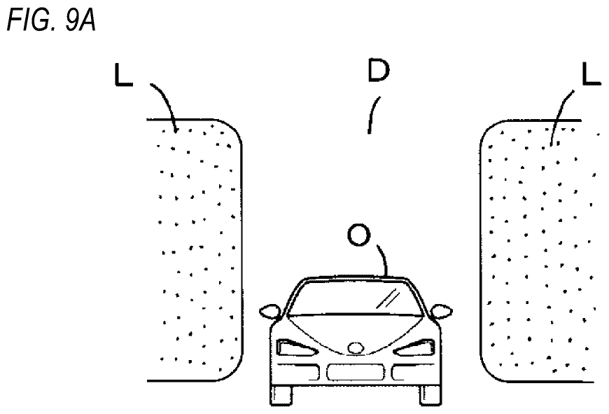

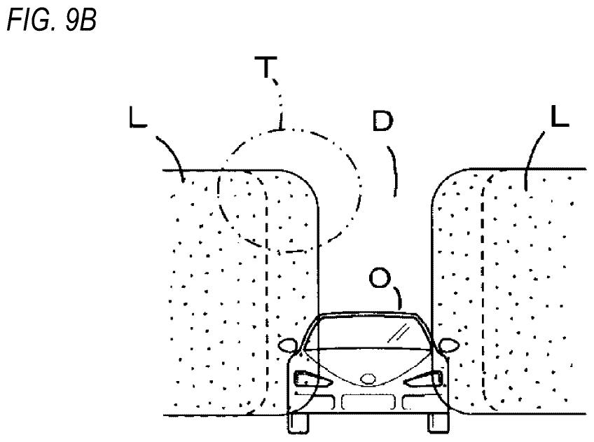

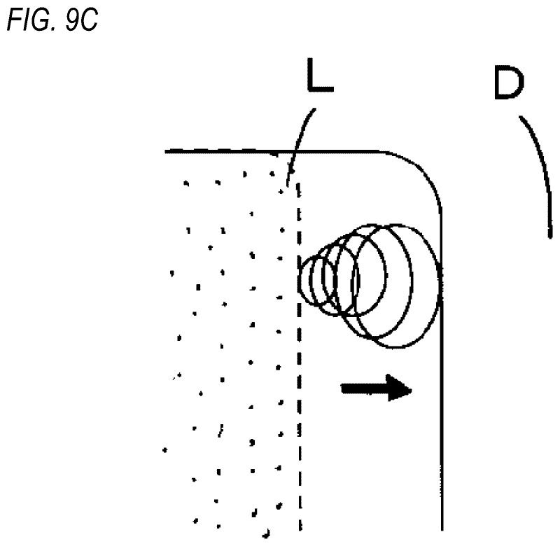

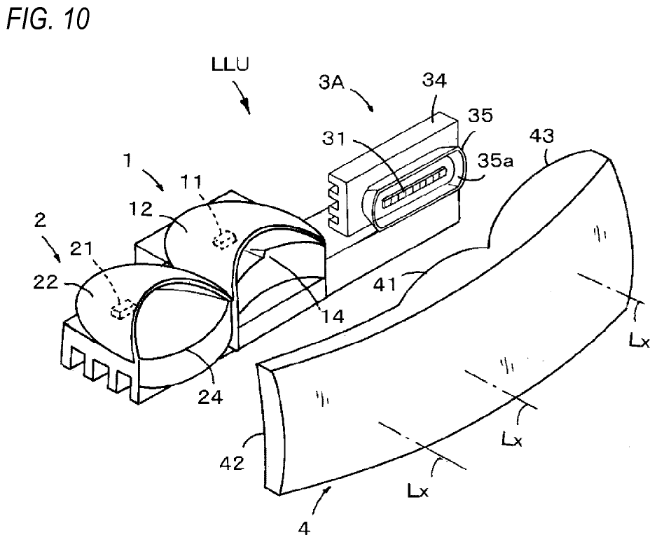

If the boundaries of the projection patterns become unclear, a glare prevention effect may be reduced when the ADB light distribution control is executed. FIGS. 9A to 9C are conceptual diagrams of the glare prevention effect, and FIG. 9C is a diagram showing a region T in FIG. 9B. When the ADB control is executed, as shown in FIG. 9A, for example, the white LEDs in a region where an oncoming vehicle O is present are turned off, and this region becomes a light-blocking region D, and the glare prevention effect can be obtained. However, if coma aberration occurs in illumination regions L adjacent to the light-blocking region D, as shown in FIGS. 9B and 9C, boundaries of the adjacent illumination regions L may advance into the light-blocking region D, making boundaries of the light-blocking region D unclear, and the glare prevention effect for the oncoming vehicle O may decrease.

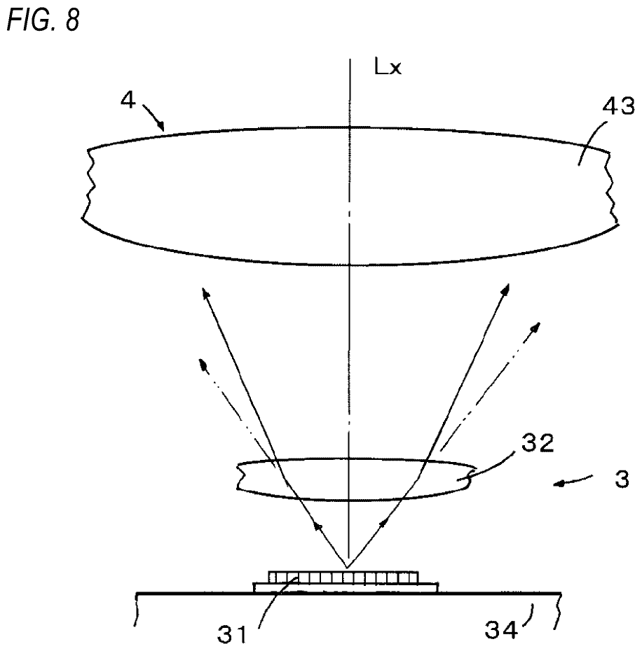

In Embodiment 1, the Hi light source unit 3 includes the correction lens 32, and the divergence of the white light emitted from the white LED is reduced by the positive refractive power of the correction lens 32. That is, as shown in FIG. 8, which is a schematic diagram of an enlarged part of the Hi light source unit 3, the white light flux (beam of light) emitted in a divergent state from the white LEDs 31 is converged by the correction lens 32 as shown by a dashed line to a solid line in FIG. 8, and an aperture effect can be obtained. Accordingly, the incident angle of the white light transmitted through the correction lens 32 and incident on the Hi lens portion 43 of the projection lens 4 is reduced, and the coma aberration is reduced. In Embodiment 1, since the Hi lens portion 43 is a convex spherical surface in which the curvature of the rear surface on which the white light is incident is larger than the curvature of the front surface, the coma aberration is also reduced from this point of view. Therefore, it is possible to prevent the boundaries of the illumination regions L from becoming unclear when the ADB light distribution control is executed, and to implement highly accurate ADB light distribution control.

As described above, in the illumination lamp unit LLU of Embodiment 1, by providing the Hi light source unit 3 with the correction lens 32, the coma aberration generated by the Hi lens portion 43 is reduced, the boundaries of the projection pattern due to the white light are clear, and the ADB light distribution control is enhanced. In the illumination lamp unit LLU of Embodiment 1, since the front surface of the projection lens 4 is formed as a uniform curved surface, the appearance thereof when observed through the outer lens 102 is simple, and the design of the illumination lamp unit LLU can be improved.

### Embodiment 2

FIG. 10 is an external view showing a schematic configuration of an illumination lamp unit LLU of Embodiment 2. Since only a configuration of a Hi light source unit 3A is different from that of Embodiment 1, descriptions of other configurations will be omitted. The Hi light source unit 3A of Embodiment 2 includes a correction reflector 35 instead of the correction lens. That is, on the front surface of the base wall 34 on which the ten white LEDs 31 are mounted, the correction reflector 35 whose front side is opened so as to surround the white LEDs 31 is attached. Part of the white light emitted from the white LEDs 31 is reflected by the correction reflector 35 and is incident on the Hi lens portion 43 of the projection lens 4.

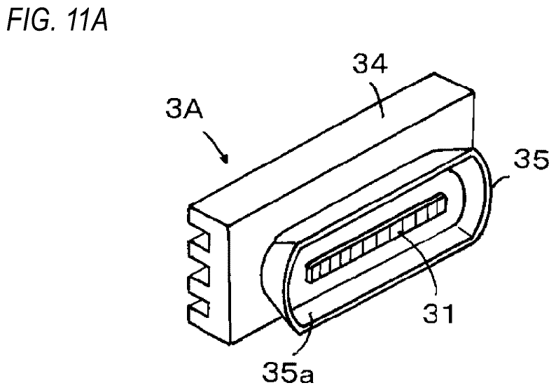

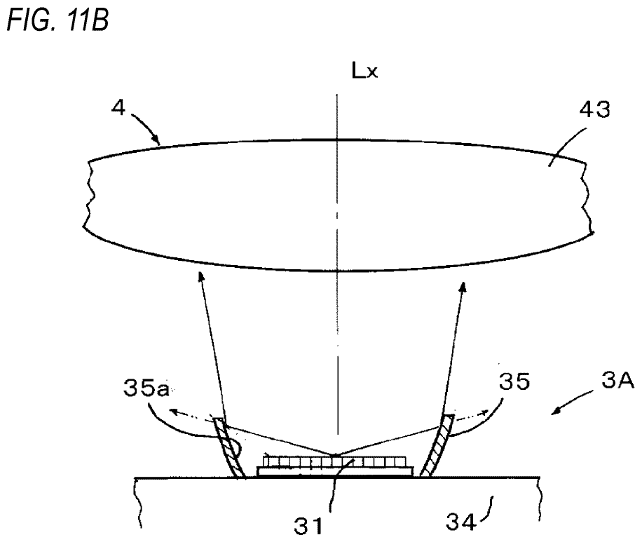

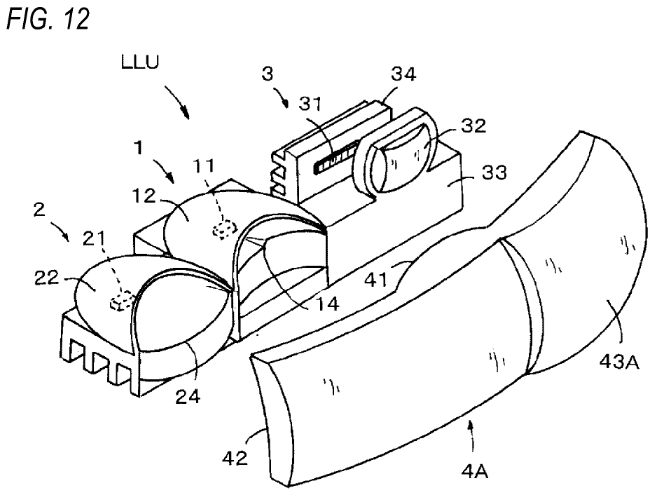

As shown in an enlarged perspective view in FIG. 11A, the correction reflector 35 is configured as a rectangular frame wall or an elliptical frame wall surrounding the ten white LEDs 31 when viewed from a front direction. At least inner surfaces of left and right frame walls 35a are configured as light reflecting surfaces. Here, inner surfaces of upper, lower, left, and right frame walls are configured as light reflecting surfaces. Here, the inner surface of each of the frame walls 35a is formed as a light reflecting surface, which is a flat surface, a parabolic surface, or a concave surface close thereto, and is inclined in the vertical direction and the horizontal direction.

Therefore, as shown in FIG. 11B, of the light emitted from the white LEDs 31, the white light emitted at a relatively large angle with respect to the optical axis Lx of the Hi lens portion 43 is deflected in a direction closer to the optical axis Lx by the correction reflector 35 and is incident on the Hi lens portion 43. In particular, the light from the left and right white LEDs 31 having a large distance from the optical axis Lx is deflected toward the optical axis Lx by the left and right frame walls 35a. Accordingly, although the degree of improvement is lower than that of Embodiment 1, the coma aberration generated in the Hi lens portion 43 is reduced, and the accuracy of the ADB light distribution control is improved.

### Embodiment 3

FIG. 12 is an external view showing a schematic configuration of an illumination lamp unit LLU of Embodiment 3, which differs from Embodiment 1 in the configuration of the projection lens. Since the configurations of the Lo light source units 1 and 2 and the Hi light source unit 3 are the same as those in Embodiment 1, descriptions thereof will be omitted. In Embodiment 3, in a projection lens 4A, a curvature of a convex spherical surface of a rear surface of a Hi lens portion 43A is smaller than that in Embodiment 1, and the rear surface is formed as a flat surface or a curved surface close to a flat surface. On the other hand, a front surface of the Hi lens portion 43A is formed as a spherical surface or an aspheric surface that protrudes further forward than the two Lo lens portions 41 and 42. As described above, since the restriction that the front surface of the Hi lens portion 43A is formed as a predetermined curved surface is released, the degree of freedom in designing the front surface of the Hi lens portion 43A is increased, and a projection lens 4A with reduced lens aberration can be obtained.

The front surface of the Hi lens portion 43A is different in shape from the front surfaces of the Lo lens portions 41 and 42, but a dimension of the Hi lens portion 43A in the vertical direction is the same as that of the Lo lens portions 41 and 42. Therefore, when the projection lens 4A is observed from the front, the entire projection lens 4A has a horizontally long rectangular appearance, and thus the projection lens 4A has a sense of unity as a whole. As described above, in the illumination lamp unit LLU of Embodiment 3, it is possible to reduce the lens aberration in the Hi light source unit 3A and implement the ADB control with high accuracy, and it is also possible to obtain sufficient design for the design in the appearance of the projection lens 4A.

### Embodiment 4

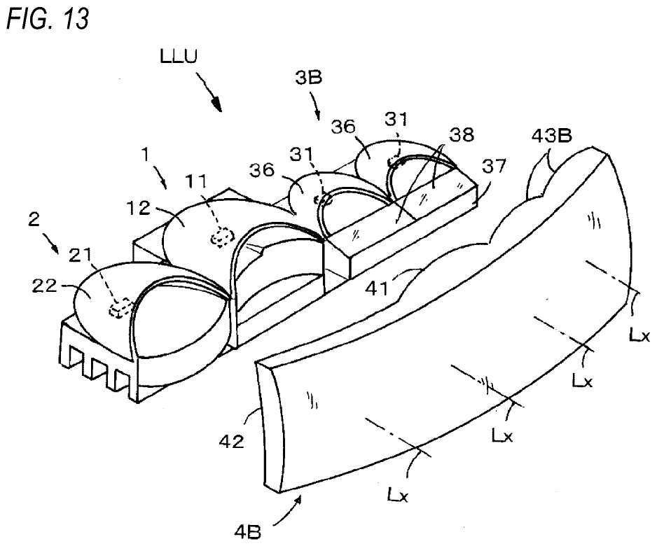

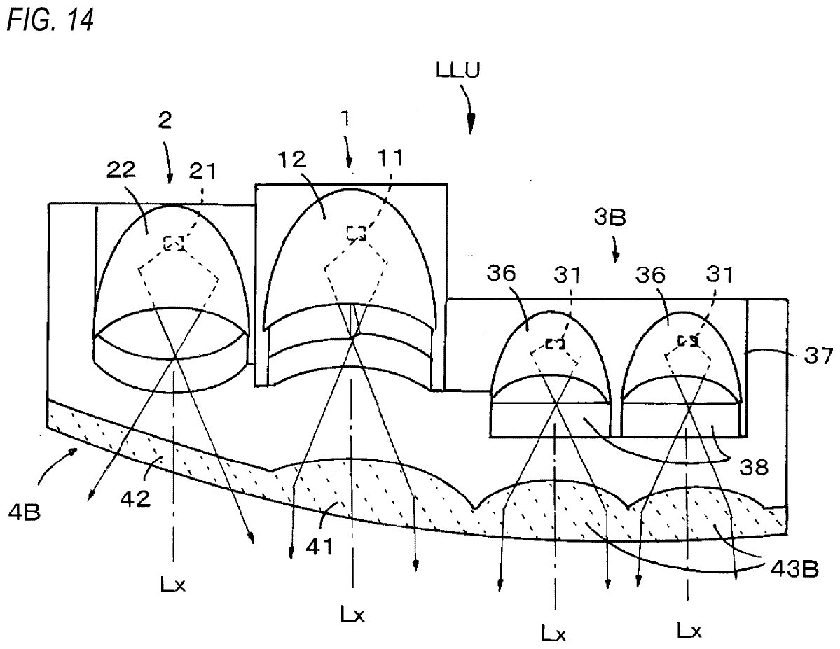

FIG. 13 is an external view showing a schematic configuration of an illumination lamp unit LLU of Embodiment 4, and FIG. 14 is a schematic plan view thereof. In the illumination lamp unit LLU, the Lo light source units 1 and 2 are the same as that of Embodiment 1, but configurations of a Hi light source unit 3B and projection lens 4B are different. The Hi light source unit 3B of Embodiment 4 does not perform the ADB light distribution control, but simply projects an additional Hi light distribution formed above the Lo light distribution, and is a light source unit used in an illumination lamp unit which is also referred to as Bi-function (Bi) light distribution control. In Embodiment 4, the Hi light source unit 3 (first Hi light source unit) that performs the ADB light distribution control of Embodiment 1 is replaced with the Hi light source unit 3B (second Hi light source unit) performing Bi light distribution control, which has a structure different from that of the Hi light source unit 3.

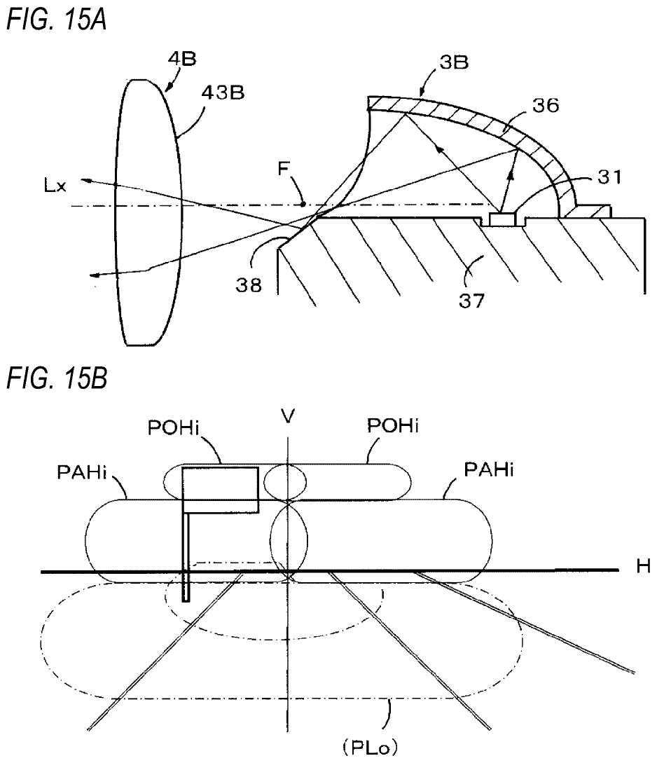

Although the basic configuration of the Hi light source unit 3B is the same as that of the Lo light source units 1 and 2, the Hi light source unit 3B includes a white LED 31 as a light source and a reflector 36 based on an ellipsoid of revolution, as shown in the vertical cross-sectional structure of FIG. 15A. The entire Hi light source unit 3B is also configured to be smaller than the Lo light source units 1 and 2, and further differs in configuration in that the Hi light source unit 3B is provided with a front mirror 38 formed integrally with a unit body 37 at a lower front side of the reflector 36. In Embodiment 3, two Hi light source units 3B having substantially the same configuration are disposed side by side in the horizontal direction.

The white LED 31 of each of the Hi light source units 3B is constituted by a chip-type LED that emits white light and is mounted on an upper surface of the unit body 37 with a light-emitting surface thereof facing vertically upward, and is supplied with power for light emission. The reflector 36 is configured as a concave reflecting mirror based on an ellipsoid of revolution, and the white LED 31 is disposed at a first focal point thereof. The front mirror 38 is configured as a plane mirror having a light reflecting surface inclined forward in the vicinity of a second focal point, that is, at a position in front of the second focal point.

The front surface of the projection lens 4 of Embodiment 4 is formed as a uniform curved surface over the entire area as in Embodiment 1. The configurations of the concentration Lo lens portion 41 and the diffusion Lo lens portion 42 corresponding to the Lo light source units 1 and 2 are also the same as those in Embodiment 1. On the other hand, a Hi lens portion 43B is divided into two portions corresponding to the two Hi light source units 3B. Each of the divided Hi lens portions 43B is formed in a smaller size than the Hi lens portion 43 of Embodiment 1, but the structure thereof is substantially the same, and a rear surface of the projection lens 4B is formed as a convex spherical surface or aspheric surface having a required curvature in the horizontal direction and the vertical direction. The two Hi lens portions 43B are disposed side by side in the horizontal direction corresponding to the two Hi light source units 3B, but optical axes Lx of the Hi lens portions 43B are oriented in slightly different directions in the horizontal direction.

The Lo light distribution in Embodiment 4 is the same as that in Embodiment 1. In the Hi light distribution, the two Lo light source units 1 and 2 and the two Hi light source units 3B simultaneously emit light. As shown in FIG. 15A, the light emitted from the white LEDs 31 in the Hi light source units 3B is reflected forward by the reflector 36, converged in the vicinity of the second focal point, and then incident on the Hi lens portions 43B of the projection lens 4. The white light is refracted by each of the Hi lens portions 43B, and is projected as an additional Hi light distribution PAHi above the Lo light distribution PLo indicated by a dashed line, as shown in FIG. 15B. Since the two Hi lens portions 43B have slightly different optical axes, the additional Hi light distributions PAHi by the two Hi light source units 3B are projected side by side in the horizontal direction. The additional Hi light distributions PAHi can be divided into an own lane side and an oncoming lane side, for example. Therefore, it is also possible to form the additional Hi light distribution PAHi on either the own lane side or the oncoming lane side by selectively or simultaneously emitting the two Hi light source units 3B.

In the Hi light source unit 3B, part of the white light reflected by the reflector 36 is reflected by the front mirror 38, and is transmitted through the Hi lens portion 43B and projected upward. Accordingly, an overhead sign (OHS) light distribution POHi is formed above the additional Hi light distribution PAHi. Although not shown, the front mirror 38 has a tilting structure and is configured to switch between a state of reflecting the white light from the reflector 36 and a state of not reflecting the white light, and thus the OHS light distribution can be freely formed.

In Embodiment 4, one Hi light source unit 3B may be provided. In this case, the one Hi light source unit 3B forms a required additional Hi light distribution. In this case, since the configuration of the Hi lens portion 43B of the projection lens 4B can be substantially the same as that of Embodiment 1, the projection lens 4 of Embodiment 1 can be used as it is.

In the illumination lamp unit LLU of Embodiment 4, since the front surface of the projection lens 4B is also formed as a uniform curved surface, the appearance thereof when observed through the outer lens 102 of the headlamp HL is simple, and the design of the illumination lamp unit LLU can be improved.

Since the illumination lamp unit LLU of Embodiment 4 has a configuration in which the Hi light source unit is different from that of Embodiment 1, the Hi light source unit 3 of Embodiment 1 or the Hi light source unit 3B of Embodiment 4 may be selected and applied as necessary. In this case, when the Hi light source unit 3B is configured by one Hi light source unit, it is not necessary to change the projection lens.

Further, in the illumination lamp unit LLU of Embodiment 4, although not shown, the shape of the front surface of the high-beam lens portion 43A may be a lens shape different from those of the low-beam lens portions 41 and 42, as in the projection lens 4A of Embodiment 3. In this case, it is not necessary to make the shape of the projection lens 4A different even when the illumination lamp unit is configured by selecting any of the Hi light source unit 3 of Embodiments 1 and 3, the Hi light source unit 3A of Embodiment 2, and the Hi light source unit 3B of Embodiment 4 as the Hi light source unit. Therefore, the appearance of the projection lens does not change when an internal configuration of the illumination lamp unit is different, and the design in this respect can be improved.

In Embodiments 1 to 4 described above, the configuration and the number of the Lo light source units and the Hi light source units constituting the illumination lamp unit can be appropriately changed. In particular, the same applies to a case in which a light source unit having a configuration other than those described in the embodiments is provided as a Lo light source unit, the description of which is omitted in the embodiments, and in this case as well, the lens shape of the front surface of the projection lens may be the same and the lens shape of the rear surface may be different.

In the present disclosure, the white LEDs constituting the Hi light source unit may be disposed in a plurality of rows in an upper-lower direction. The configuration of the Lo light source unit is not limited to the configurations in the embodiments.

Regarding the configuration of the projection lens in the present disclosure, in particular, the configurations of the lens portions for obtaining the Hi light distribution and the Lo light distribution, various modifications can be considered for the lens shape as long as a refractive power required in each of the lens portions, in particular, the refractive power in the vertical direction and the horizontal direction satisfies the requirement. The front surface of the projection lens may be a flat surface, and in this case, the rear surface of the projection lens may be formed as a convex curved surface in order to obtain a required refractive power in each of the lens portions.

The present application is based on Japanese Patent Application No. 2022-155687, Japanese Patent Application No. 2022-155688, and Japanese Patent Application No. 2022-155689 filed on Sep. 29, 2022, and the contents are incorporated herein by reference.

1. A vehicle lamp comprising:
a low-beam light source unit;
a high-beam light source unit; and
a projection lens that projects light from each of the light source units to form a required light distribution, wherein
in the projection lens, a low-beam lens portion that projects light from the low-beam light source unit to form a low-beam light distribution and a high-beam lens portion that projects light from the high-beam light source unit to form a high-beam light distribution are integrally formed, and
the high-beam light source unit includes a correction optical part that reduces lens aberration.

2. The vehicle lamp according to claim 1, wherein
the correction optical part includes an optical member that reduces an incident angle of light emitted from the light source unit and incident on the high-beam lens portion.

3. The vehicle lamp according to claim 2, wherein
the correction optical part includes a lens having a positive refractive power.

4. The vehicle lamp according to claim 2, wherein
the correction optical part includes a reflector that converges and reflects light.

5. The vehicle lamp according to claim 1, wherein
a front surface of the projection lens is formed as a uniform curved surface, and a rear surface of the projection lens is formed such that the high-beam lens portion and the low-beam lens portion have different curved surfaces.

6. The vehicle lamp according to claim 5, wherein
the correction optical part of the high-beam light source unit is configured as a lens having a refractive power in a vertical direction and a horizontal direction.

7. The vehicle lamp according to claim 6, wherein
the front surface of the projection lens is a curved surface that is curved in both the vertical direction and the horizontal direction.

8. The vehicle lamp according to claim 1, wherein
a front surface of the projection lens is configured such that the high-beam lens portion and the low-beam lens portion have different curved surfaces.

9. The vehicle lamp according to claim 1, wherein
the low-beam light source unit includes a concentration low-beam light source unit that illuminates a central region including a hot zone of the low-beam light distribution and a diffusion low-beam light source unit that illuminates a wide region wider than the central region,
a lens portion of the concentration low-beam light source unit is configured as a lens having a refractive power in a vertical direction and a horizontal direction, and
a lens portion of the diffusion low-beam light source unit is configured as a lens having a refractive power in the vertical direction and no refractive power in the horizontal direction.

10-14. (canceled)

15. A vehicle lamp comprising:
a low-beam light source unit;
a high-beam light source unit; and
a projection lens that projects light from each of the light source units to form a required light distribution, wherein
in the projection lens, a low-beam lens portion that projects light from the low-beam light source unit to form a low-beam light distribution and a high-beam lens portion that projects light from the high-beam light source unit to form a high-beam light distribution are integrally formed,
a front surface of the projection lens is formed as a uniform curved surface or flat surface, and
a rear surface of the projection lens is formed such that at least one of the lens portions has a different curved surface.

16. The vehicle lamp according to claim 15, wherein
the low-beam light source unit includes a concentration low-beam light source unit that illuminates a central region including a hot zone of the low-beam light distribution and a diffusion low-beam light source unit that illuminates a wide region wider than the central region,
a lens portion of the concentration low-beam light source unit is configured as a lens having a refractive power in a vertical direction and a horizontal direction,
a lens portion of the diffusion low-beam light source unit is configured as a lens having a refractive power in the vertical direction and no refractive power in the horizontal direction, and
the high-beam lens portion is configured as a lens having a refractive power in the vertical direction and the horizontal direction.

17-18. (canceled)

19. A vehicle lamp comprising:
a low-beam light source unit;
a high-beam light source unit; and
a projection lens that projects light from each of the light source units to form a required light distribution, wherein
a low-beam lens portion that projects light from the low-beam light source unit to form a low-beam light distribution and a high-beam lens portion that projects light from the high-beam light source unit to form a high-beam light distribution are integrally formed,
the light source units are capable of having different structures, and
a front surface of the projection lens has the same lens shape regardless of a difference in the light source units.

20. The vehicle lamp according to claim 19, wherein
the front surface of the projection lens is formed as a uniform curved surface or flat surface, and a rear surface of the projection lens is formed with different curved surfaces corresponding to the disposed light source units.

21. The vehicle lamp according to claim 20, wherein
front surfaces of the low-beam lens portion and the high-beam lens portion are formed as the same curved surface or flat surface, and
rear surfaces of the low-beam lens portion and the high-beam lens portion are formed as different curved surfaces.

22. The vehicle lamp according to claim 20, wherein
the low-beam light source unit includes a concentration low-beam light source unit that illuminates a central region including a hot zone of the low-beam light distribution and a diffusion low-beam light source unit that illuminates a wide region wider than the central region,
the front surface of the projection lens is formed as a uniform curved surface or flat surface, and
a rear surface of a low-beam lens portion of the concentration low-beam light source unit and a rear surface of a low-beam lens portion of the diffusion low-beam light source unit are formed as different curved surfaces.

23. The vehicle lamp according to claim 20, wherein
the high-beam light source unit includes either a first high-beam light source unit that includes a plurality of light-emitting elements capable of selectively emitting light, and projects light emitted from each of the light-emitting elements with a required light distribution by the high-beam lens portion, or a second high-beam light source unit that projects light emitted from one light-emitting element and converged and reflected by a reflector with a required light distribution by the high-beam lens portion,
and front surfaces of high-beam lens portions of the first high-beam light source unit and the second high-beam light source unit are formed as the same curved surface or flat surface.

24. The vehicle lamp according to claim 23, wherein
rear surfaces of the high-beam lens portions of the first high-beam light source unit and the second high-beam light source unit are formed as different curved surfaces.

25. The vehicle lamp according to claim 24, wherein
the first high-beam light source unit includes a correction optical part that reduces an incident angle of light emitted from the first high-beam light source unit and incident on the high-beam lens portion, and
the correction optical part includes a correction lens having a positive refractive power or a correction reflector that converges light.

26. The vehicle lamp according to claim 24, wherein
the second high-beam light source unit is capable of forming an additional high-beam light distribution above the low-beam light distribution and further forming an overhead light distribution above the additional high-beam light distribution.

27. The vehicle lamp according to claim 24, wherein
the second high-beam light source unit includes a plurality of light source units, and the high-beam lens portion includes a plurality of high-beam lens portions corresponding to the plurality of light source units.

28. (canceled)
